(19) United States
(12) Patent Application Publication
(10) Pub. No.: US 2026/0329946 A1
(43) Pub. Date: Oct. 22, 2026

(54) AI-Interpretable Metadata System for Autonomous Interaction with Web and Device-Based Resources

(71) Applicant: Matthew Smith, Maineville, OH (US)

(72) Inventor: Matthew Smith, Maineville, OH (US)

(73) Assignee: Velcryn, LLC, Blue Ash, OH (US)

(21) Appl. No.: 19/186,571

(22) Filed: Apr. 22, 2025

(51) Int. Cl. G06F 16/907

(52) U.S. Cl. CPC G06F 16/907

(57) ABSTRACT

A structured metadata file format specifically designed for interpretation by artificial intelligence (AI) systems, enabling autonomous access and interaction with web servers, IoT devices, mobile applications, and digitally accessible systems. The metadata file includes structured definitions of API endpoints, machine-readable authentication protocols, data schemas, usage guidelines, dynamic policy update mechanisms, and real-time compliance enforcement. This architecture allows AI systems to securely parse and integrate with digital infrastructure, ensuring efficient, ethical, and autonomous operation across distributed networks and device ecosystems.

### CROSS-REFERENCE TO RELATED APPLICATIONS

(Not Applicable)

### TECHNICAL FIELD

This invention pertains to artificial intelligence systems and their autonomous interactions with web-based resources, IoT devices, smart appliances, mobile applications, and other electronically accessible systems. More specifically, it relates to structured metadata files that govern and direct AI behavior, access control, and ethical decision-making across both open and closed network architectures.

### BACKGROUND OF THE INVENTION

Conventional web systems use metadata standards like robots. txt and sitemap. xml for search engine directives and structural discovery. For API interaction, tools such as OpenAPI (Swagger) provide human-readable documentation. However, these standards are not designed for autonomous systems like modern artificial intelligence agents. AI systems require structured, machine-readable, self-enforcing instructions to interact with electronic systems securely, ethically, and efficiently without human oversight.

The problem is twofold: first, current metadata is not optimized for AI comprehension; second, compliance, access control, and ethical boundaries are not technically enforceable through metadata alone. This invention addresses both issues with a unified metadata framework.

### SUMMARY OF THE INVENTION

The invention introduces a universally structured metadata file specifically optimized for AI systems. It enables autonomous interpretation and decision-making through: ⋅Explicit API endpoint definitions; ⋅Structured authentication schemas; ⋅Detailed data schemas and parsing logic; ⋅Structured ethical and usage guidelines; ⋅Real-time metadata enforcement layers; ⋅Cryptographic and blockchain-based compliance modules; ⋅Dynamic policy update engines; ⋅Behavioral monitoring and feedback systems.

The invention supports multiple deployment models:

FIG. 1: Open System architecture where each device hosts its own metadata file;

FIG. 2: Closed System architecture using a centralized metadata file;

FIG. 2B: Closed Universal architecture with preloaded metadata into the AI;

FIG. 3/3B: Real-time vs. preloaded metadata flows;

FIG. 4/5: Authenticated vs. unauthenticated metadata access;

FIG. 6: Internal enforcement flow with cryptographic checks, smart contracts, violation handling, and policy updates.

### BRIEF DESCRIPTION OF THE DRAWINGS

FIG. 1 is a diagram illustrating an open system architecture wherein individual AI metadata files are hosted directly on each device and accessed via a digital interface. FIG. 2 is a diagram illustrating a closed system architecture where a centralized metadata file governs all device interactions across the network. FIG. 2B is a diagram illustrating a closed universal system where metadata is preloaded into the AI system prior to its interaction with distributed devices. FIG. 3 is a flow diagram showing the live, real-time interaction path: AI system to interface to metadata file to device endpoint. FIG. 3B is a flow diagram showing preloaded metadata flow where the AI uses internal metadata before reaching the device via network interface. FIG. 4 is a diagram depicting authenticated metadata interaction with a compliance layer acting as a firewall between metadata and system endpoints. FIG. 5 is a diagram showing an unauthenticated metadata configuration where data passes through without compliance enforcement. FIG. 6 is a system architecture diagram illustrating dynamic policy enforcement, including a policy update engine, feedback loop, compliance log, smart contracts, and cryptographic validation modules.

### DESCRIPTION OF THE PREFERRED EMBODIMENT

In one preferred embodiment, each device or resource on a network (e.g., server, IoT device, or mobile application) stores its own metadata file containing all relevant API and schema details. These files reside at standardized locations (such as/ai-meta.json or equivalent) and can be accessed via standard HTTP, socket-based communication, or system-level queries.

In another embodiment, a centralized metadata file aggregates this information, either stored on a secure server or embedded within a distributed file system. In this case, the AI only accesses one file for all directives, which may also link or reference external metadata schemas.

In the universal embodiment (FIGS. 2B and 3B), the metadata file is loaded into the AI at training time or pre-deployment. This model allows edge-AI or offline AI agents to interact with local systems or environments without needing to fetch data from external metadata stores.

### DETAILED DESCRIPTION

1. API Endpoint Metadata: Each endpoint is explicitly defined with path, method, parameters, expected responses, rate limits, content types, and interaction flags (e.g., critical, sensitive, public). These help the AI determine what to access, avoid, or handle differently.
2. Authentication Schema: Defines authorization protocols including OAuth, API keys, HMAC signatures, and bearer tokens. It includes token expiration, renewal mechanisms, and challenge-response sequences for fully autonomous interaction.
3. Structured Data Schemas: Defines input/output object structures, property types, nested relationships, conditional constraints, and expected usage contexts. Designed for fast parsing and real-time mapping into AI data models.
4. AI Usage and Ethical Guidelines: May include allowed hours of access, privacy boundaries (e.g., no personally identifiable data), rate limits, ethical constraints (e.g., no autonomous purchase behavior), and contextual opt-outs.
5. Technical Compliance Enforcement: Optionally enforces constraints via technical means:
   Embedded cryptographic hashes to validate schema origin and prevent tampering.
   Smart contracts for real-time access control and behavior recording.
   Blockchain ledger writes for audit trails.
6. Dynamic Policy Updates: Metadata may reference live endpoints for real-time policy updates. These are verified by digital signature and timestamp, allowing systems to adapt to evolving rules without retraining AI agents.
7. Behavioral Monitoring and Feedback Loop: AI activity is monitored via audit logs, real-time action evaluation, and behavioral deltas. The system can flag out-of-bounds behavior, auto-update usage policies, or adjust the AI's access profile.

### Implementation Scenarios

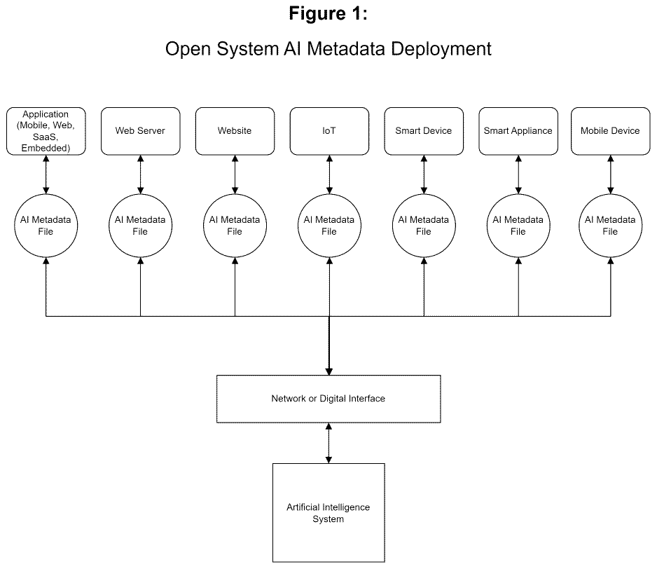

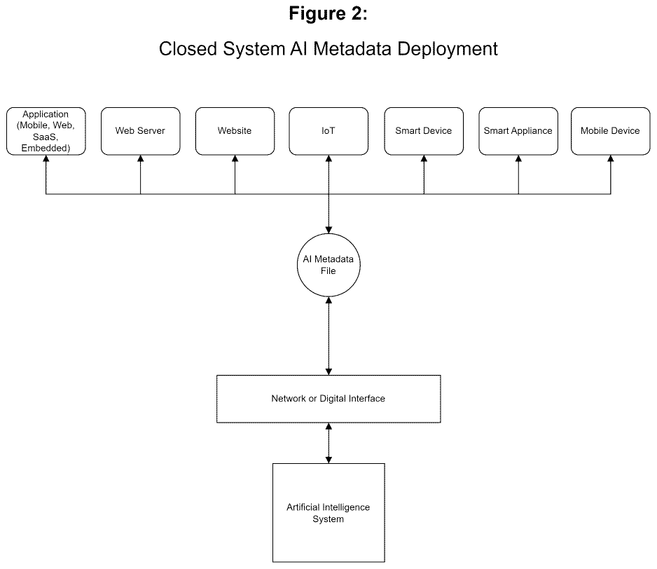

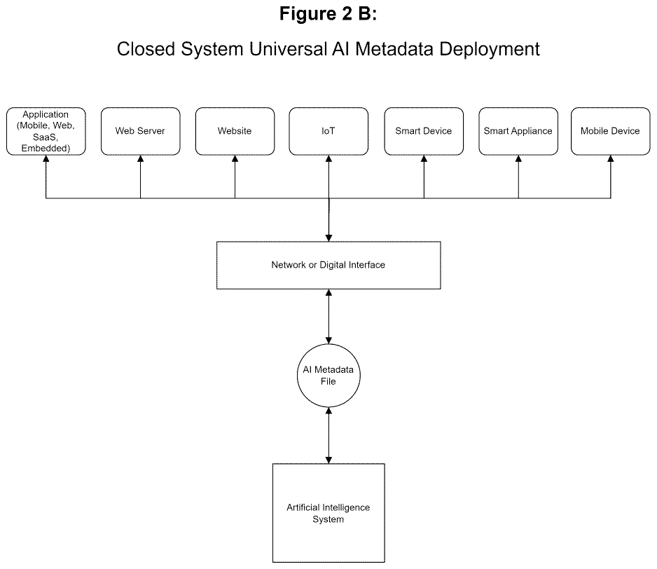

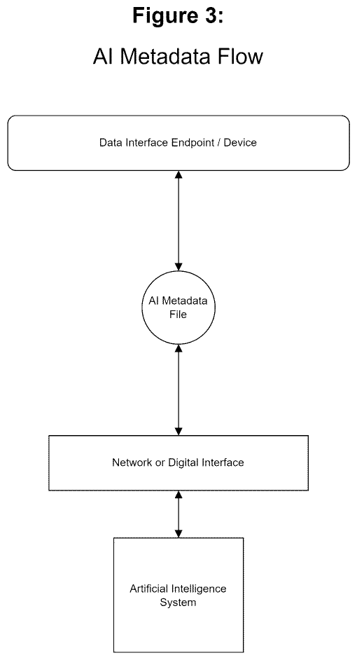

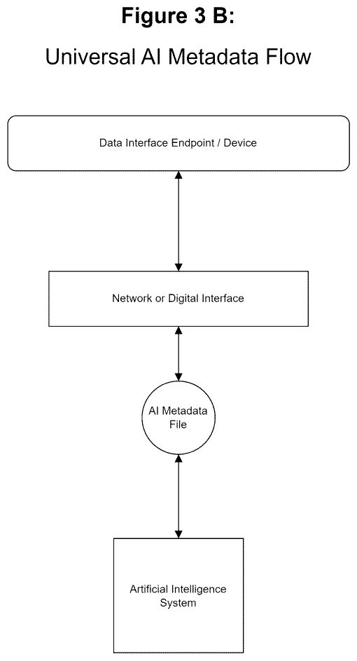

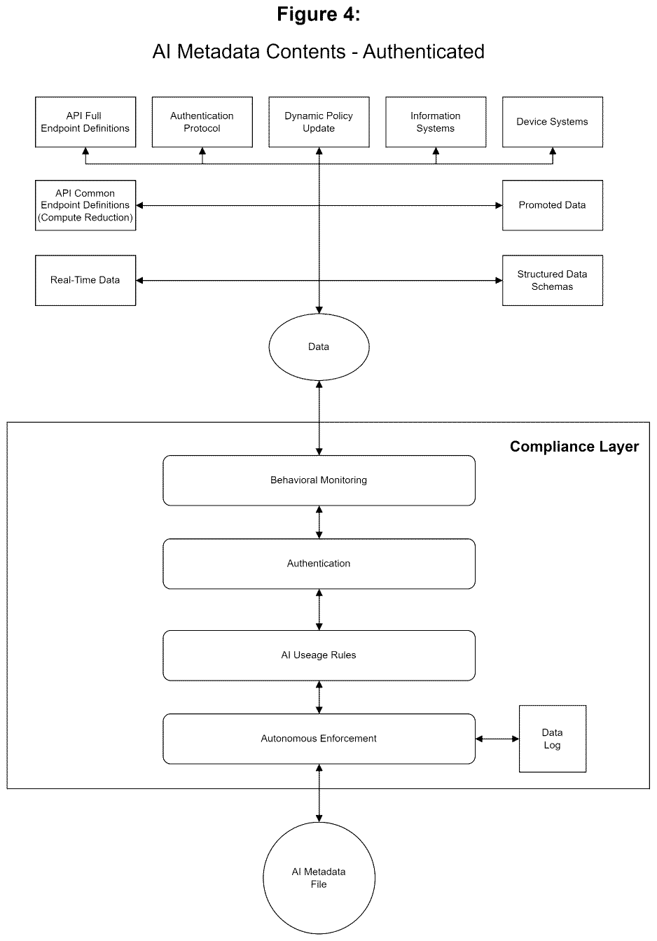

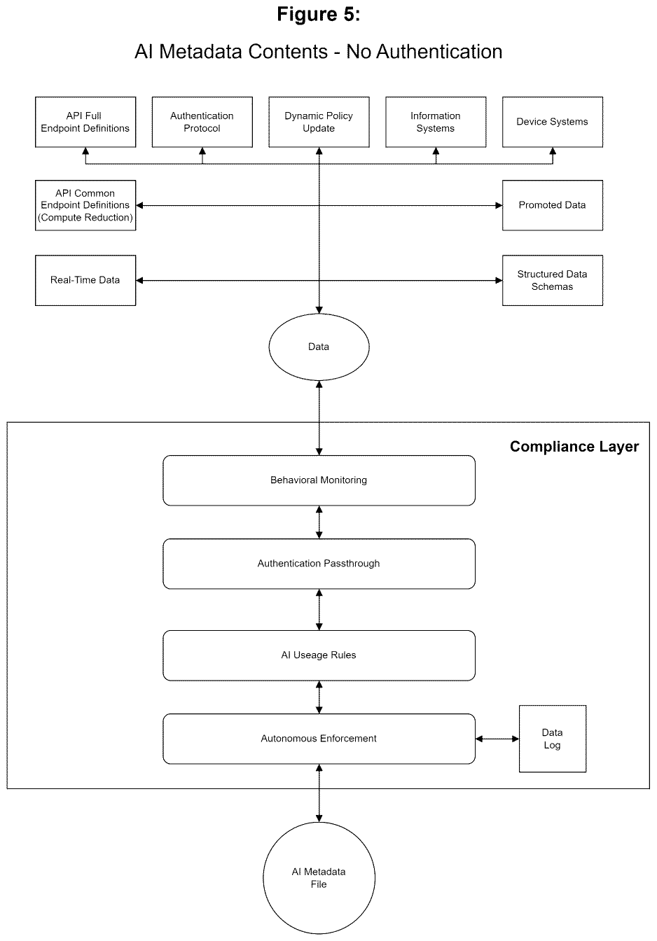

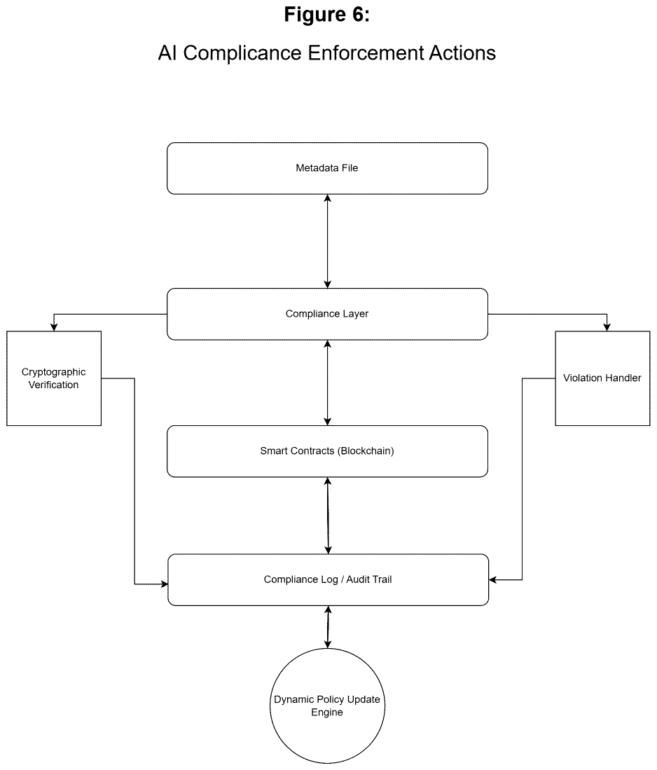

⋅A cloud-based AI assistant accesses home IoT devices using metadata hosted on each device (FIG. 1). ⋅A healthcare AI interacts only with a central metadata repository that defines approved endpoints and authentication rules (FIG. 2). ⋅An AI drone uses preloaded metadata to interact with field sensors while offline (FIGS. 2B, 3B). ⋅In high-risk environments, the metadata firewall (FIG. 4) enforces all ethical rules and access constraints before passing data to or from the device. ⋅For low-risk applications, metadata flows directly without validation (FIG. 5). ⋅If compliance is required, the system logs behavior (FIG. 6), flags violations, and enforces rules through smart contract gating.

1. A structured metadata file specifically formatted for autonomous interpretation by artificial intelligence (AI) systems, comprising:
a. API endpoint definitions optimized explicitly for AI readability;
b. Structured authentication schemas defined for AI-managed access;
c. Structured data schemas for autonomous AI parsing and integration;
d. Ethical guidelines and usage policies for compliant and responsible interaction;
e. Compliance enforcement mechanisms employing technical verification methods;
f. A dynamic update mechanism enabling real-time policy modifications;
g. Behavioral monitoring and an autonomous feedback loop.

2. The structured metadata file of claim 1, wherein the file is deployable across web servers, IoT devices, smart appliances, mobile devices, and other electronically accessible systems.

3. The structured metadata file of claim 1, wherein structured authentication schemas include OAuth flows, API keys, token lifecycle rules, and cryptographic signatures.

4. The structured metadata file of claim 1, further comprising optional cryptographic enforcement layers, including smart contract execution and blockchain-based compliance verification.

5. A method for AI system interaction utilizing the metadata file of claim 1, comprising:
a. Retrieving and parsing structured metadata;
b. Performing authentication and accessing defined endpoints;
c. Parsing structured data schemas and integrating content;
d. Enforcing compliance rules and ethical boundaries;
e. Executing policy updates in response to real-time environmental changes;
f. Monitoring behavior and triggering adaptive feedback policies.

6. The method of claim 5, further comprising:
a. Logging all AI interactions in an immutable compliance log;
b. Automatically flagging violations and initiating policy-reinforced responses.

7. A system comprising:
a. A structured metadata repository;
b. One or more AI agents configured to parse said metadata;
c. A compliance engine monitoring agent behavior;
d. A policy update engine delivering real-time behavioral constraints;
e. A cryptographic validation layer supporting trustless integrity checks;
f. A feedback loop adjusting access permissions in response to agent behavior.
Conclusion
This invention enhances AI's autonomous capability to interact ethically and securely with digital resources. With universal deployment across open, closed, and preloaded architectures, and with optional cryptographic enforcement and behavioral logging, this metadata system provides a powerful foundation for scalable, compliant, and adaptive AI operations in enterprise and consumer contexts.
